(19) United States
(12) Patent Application Publication
(10) Pub. No.: US 2017/0185579 A1
(43) Pub. Date: Jun. 29, 2017

(54) METHOD AND DEVICE FOR LANGUAGE SETTING

(71) Applicant: Beijing Xiaomi Mobile Software Co., Ltd., Beijing (CN)

(72) Inventors: Wenbo ZHU, Beijing (CN); Wei YU, Beijing (CN); Jianing SONG, Beijing (CN)

(21) Appl. No.: 15/390,729

(22) Filed: Dec. 27, 2016

(30) Foreign Application Priority Data
Dec. 29, 2015 (CN) 201511017747.9
Aug. 17, 2016 (CN) 201610681553.7

(51) Int. Cl. G06F 17/27; G06F 3/0482

(52) U.S. Cl. CPC G06F 17/275; G06F 3/0482

(57) ABSTRACT

A method and a device for language setting are provided. The method includes: obtaining current geographic location information of an electronic device; extracting at least one language which is associated with the geographical location information from a predefined language list; and inserting the at least one language into a specified position in the predefined language list.

### CROSS-REFERENCE TO RELATED APPLICATION

This application is based on and claims priority to Chinese Patent Application No. 201511017747.9 filed on Dec. 29, 2015, entitled “METHOD AND DEVICE FOR LANGUAGE SETTING” and Chinese Patent Application No. 201610681553.7 filed on Aug. 17, 2016, entitled “METHOD AND DEVICE FOR LANGUAGE SETTING” which are incorporated herein by reference in their entirety.

### FIELD

The present disclosure generally relates to the technical field of computer technology, and more particularly to a method and a device for language setting.

### BACKGROUND

With the development of import and export trade, electronic devices produced by one country may be used by users from another country. When the language used by a user from another country is different from the language used by the country producing the electronic device, the user needs to set the language of the electronic device.

### SUMMARY

The present disclosure provides a method and a device for language setting.

According to a first aspect of the embodiments of the present disclosure, a method for language setting is provided. The method includes: obtaining current geographic location information of an electronic device; extracting at least one language which is associated with the geographic location information from a predefined language list; and inserting the at least one language into a specified position in the predefined language list.

According to a second aspect of the embodiments of the present disclosure, a method for language setting is provided. The method includes: obtaining current geographic location information of an electronic device when it is booted for the first time; determining at least one language which is associated with the geographic location information from a predefined language list of the electronic device; and selecting one of the at least one language as a setting result for a language option of the electronic device.

According to a third aspect of the embodiments of the present disclosure, a device for language setting is provided, comprising: a processor; a memory for storing processor-executable instructions; wherein the processor is configured to: obtain current geographic location information of an electronic device; extract, from a predefined language list, at least one language which is associated with the geographic location information; and insert the at least one language into a specified position in the predefined language list.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1A is a flow diagram illustrating a method for language setting according to an exemplary embodiment.

FIG. 1B is a flow diagram illustrating another method for language setting according to another exemplary embodiment.

FIG. 2A is a flow diagram illustrating a method for language setting according to another exemplary embodiment.

FIG. 2B shows a schematic diagram for determining a setting result for a region option according to an exemplary embodiment.

FIG. 2C shows a schematic diagram for providing a language option according to an exemplary embodiment.

FIG. 2D shows a schematic diagram for displaying at least one language according to an exemplary embodiment.

FIG. 2E shows a schematic diagram for determining a setting result for a language option according to an exemplary embodiment.

FIG. 2F is a flow diagram illustrating a method for language setting according to another exemplary embodiment.

FIG. 2G is a flow diagram illustrating a method for language setting according to another exemplary embodiment.

FIG. 2H is a flow diagram illustrating a method for language setting according to another exemplary embodiment.

FIG. 3A is a block diagram illustrating a device for language setting according to an exemplary embodiment.

FIG. 3B is a block diagram illustrating a device for language setting according to another exemplary embodiment.

FIG. 4A is a block diagram illustrating a device for language setting according to an exemplary embodiment.

FIG. 4B is a block diagram illustrating a device for language setting according to another exemplary embodiment.

FIG. 5 is a block diagram illustrating a device for language setting according to an exemplary embodiment.

### DETAILED DESCRIPTION

Reference will now be made in detail to example embodiments, examples of which are illustrated in the accompanying drawings. The following description refers to the accompanying drawings in which same numbers in different drawings represent same or similar elements unless otherwise described. The implementations set forth in the following description of example embodiments do not represent all implementations consistent with the present disclosure. Instead, they are merely examples of devices and methods consistent with aspects related to the present disclosure as recited in the appended claims.

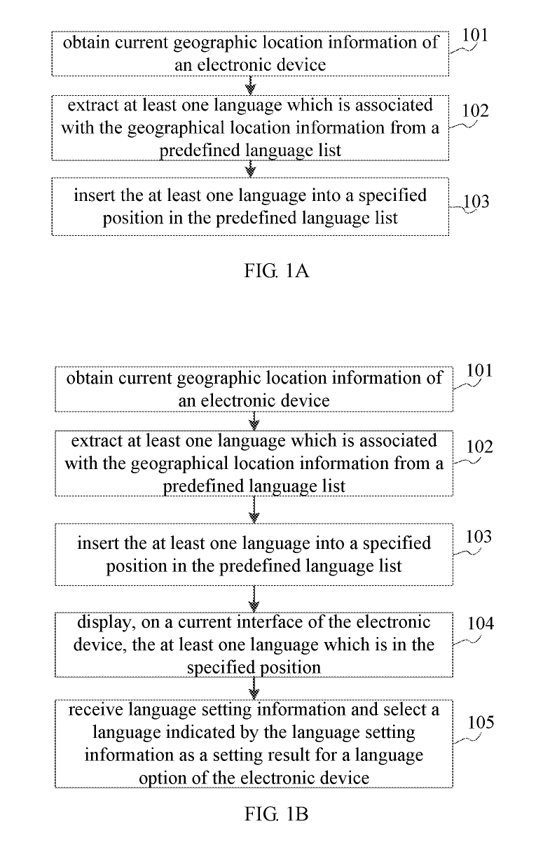

FIG. 1A is a flow diagram illustrating a method for language setting according to an exemplary embodiment. As shown in FIG. 1A, the method for language setting includes the following steps.

In step 101, current geographic location information of an electronic device is obtained.

In step 102, at least one language which is associated with the geographic location information is extracted from a predefined language list.

In step 103, the at least one language is inserted into a specified position in the predefined language list.

Thus, the method for language setting provided in the present disclosure enables the electronic device to directly provide the at least one language to a subsequent user when setting a language option, so that the user can search the language list to obtain the at least one language associated with the current geographic location information without scrolling the language list up and down, and directly select one of the at least one language as a setting result for the language option of the electronic device. Accordingly, the user does not have to search the language list for a language which is associated with the geographic location information by scrolling it up and down after setting a region option, and thus the efficiency for setting the language option of the electronic device is improved.

Alternatively, reference is made to a flow diagram shown in FIG. 1B illustrating another method for language setting. As shown in FIG. 1B, subsequent to step 103, the method may further include the following steps.

In step 104, the at least one language which is in the specified position is displayed on a current interface of the electronic device.

In step 105, language setting information is received, and a language indicated in the language setting information is selected as a setting result for a language option of the electronic device.

Thus, the method for language setting provided in the present disclosure can display the at least one language which is associated with the current geographic location information. Due to a great probability for the at least one language being selected as the setting result for the language option, the probability for the user to select a language from the displayed at least one language as the setting result for the language option is greater, thus improving the efficiency for setting the language option.

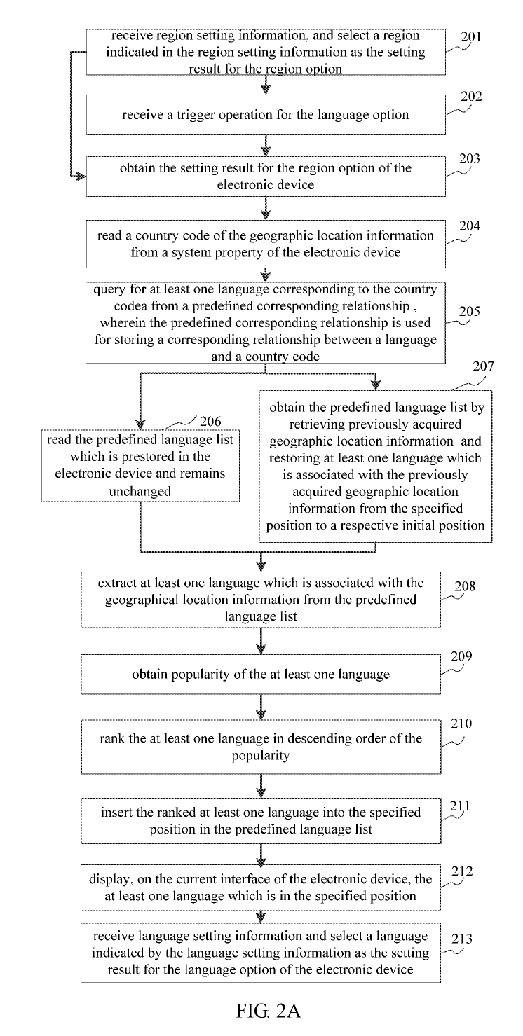

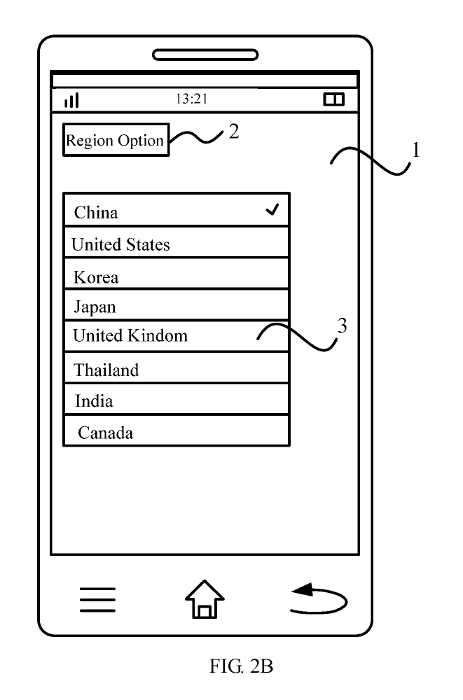

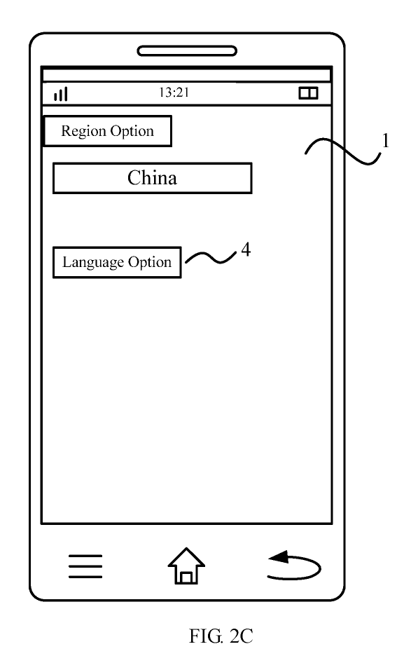

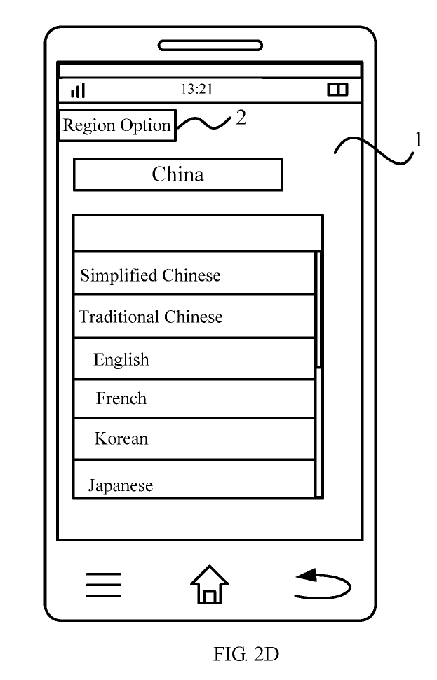

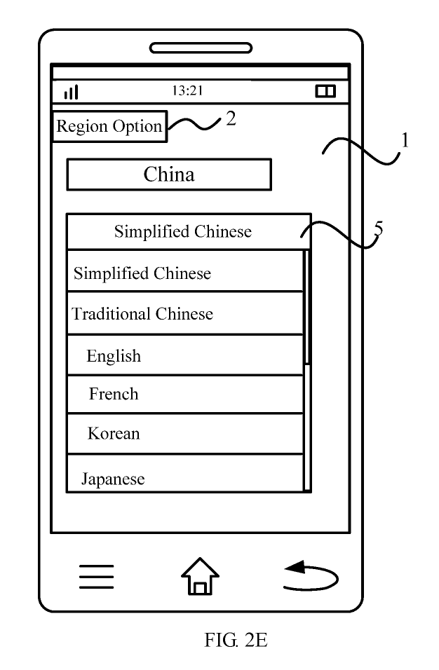

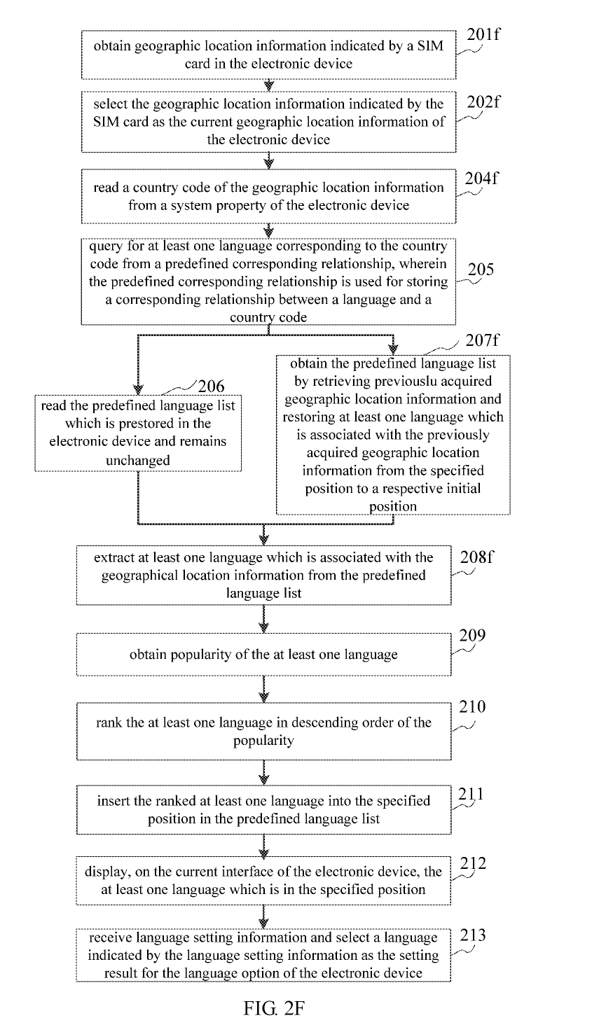

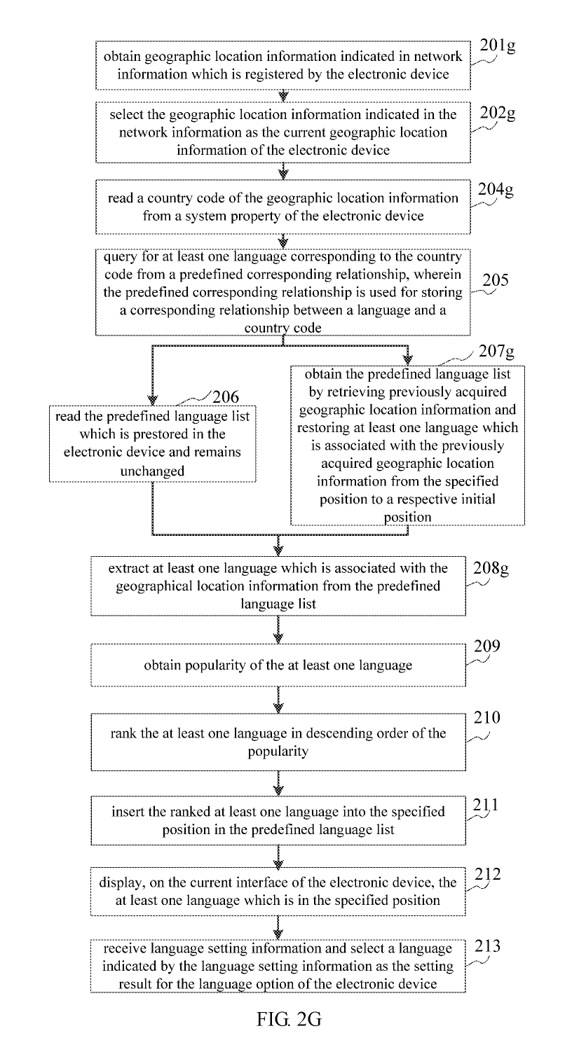

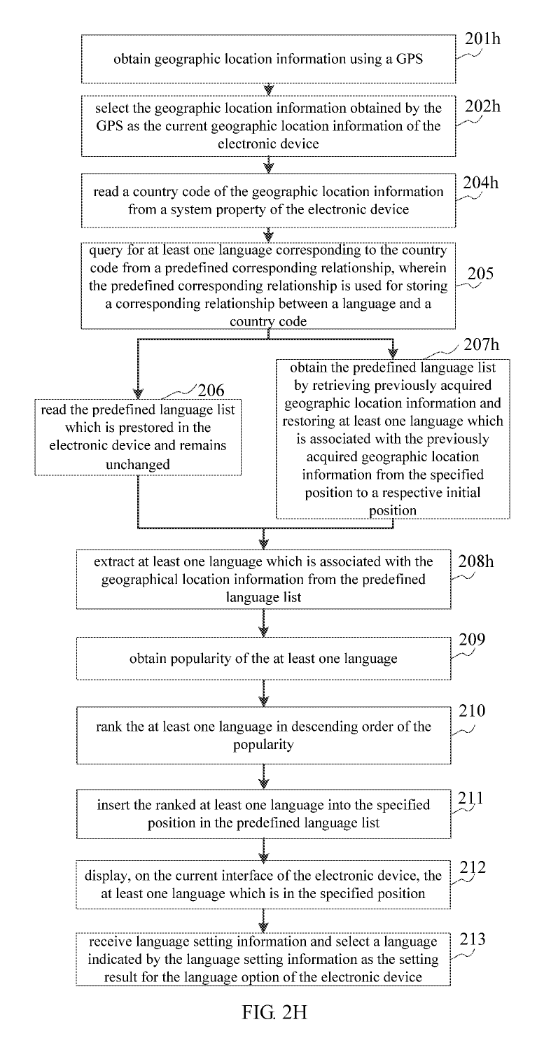

In a first implementation, the current geographic location information of the electronic device is the setting result obtained after the region option is set by the user. Referring to FIG. 2A, a flow diagram illustrates a method for language setting according to another exemplary embodiment, wherein as an example, the method for language setting is applied in an electronic device. As shown in FIG. 2A, the method for language setting includes the following steps.

In step 201, region setting information is received, and a region indicated in the region setting information is selected as a setting result for a region option.

Typically, if a user needs to modify a language option of an electronic device, the electronic device may display a plurality of languages provided as a predefined language list on a current interface. Since there are many languages provided in the electronic device, the user has to search the predefined language list by scrolling up and down for a language needed to be set, resulting in low efficiency for setting the language option.

In the embodiment, the electronic device associates a language with a region. The user may first set the region through the region option. The electronic device may display languages corresponding to the region on the current interface. Then, the user can find a language needed from the displayed languages without scrolling the language list up and down, thus improving the efficiency for setting the language option.

According to the method provided in the embodiment, the electronic device first needs to receive region setting information triggered by the user, and select the region indicated in the region setting information as the setting result for the region option. For example, as shown in FIG. 2B, a display interface 1 of the electronic device provides a region option 2. After region option 2 is triggered by the user, region list 3 will be presented. The user selects “China” in the region list, and the electronic device selects China as the setting result for region option 2.

After setting the region option, the electronic device also needs to set a language option. At this point, the electronic device may directly perform step 203. In other words, after setting the region option, the electronic device will automatically modify the predefined language list according to the region without the user's trigger operation, which may reduce operations performed by the user during the process of setting the language option, and thus improve the efficiency for setting the language option. Alternatively, the electronic device may perform step 202. In this case, the user needs to manually trigger the electronic device to display the language option. Upon the reception of the trigger operation, the electronic device will modify the predefined language list according to the region. It may avoid a waste of resources caused by automatically modifying the predefined language list in such a situation that the user only needs to set the region option without the need to set the language option, thus resources are saved.

In step 202, the trigger operation for the language option is received.

The user manually triggers the language option provided by the electronic device, which will trigger the electronic device to modify the predefined language list for the user to set languages. Then, the electronic device receives the trigger operation.

For example, as shown in FIG. 2C, a display interface 1 of the electronic device provides a language option 4. The user triggers the language option 4, and then the electronic device modifies the predefined language list.

In step 203, the setting result for the region option of the electronic device is obtained.

Alternatively, the setting result for the region option obtained by the electronic device is the current geographic location information of the electronic device.

In step 204, a country code of the setting result is read from a system property of the electronic device.

To facilitate the user to select a language which is associated with the setting result for the region option, the electronic device may associate languages with the setting result in advance. When implemented, the country code of the setting result may associate with language. In this case, the electronic device needs to first determine the country code according to the setting result. A country code is used to uniquely identify a region. For example, the country code for China is 86.

The system property of the electronic device contains the country code of the setting result. After setting the region option, the electronic device will accordingly modify the country code in the system property to the country code corresponding to the present setting result. Thus, the electronic device can directly read the country code of setting result from the system property.

For example, the electronic device may read the country code of the setting result from the system property “ro.miui.region.”

In step 205, at least one language corresponding to the country code may be queried from a predefined corresponding relationship, wherein the predefined corresponding relationship is used for storing a corresponding relationship between a language and a country code.

The electronic device stores the predefined corresponding relationship between a country code and at least one language corresponding to the country code. After reading the country code, it may obtain at least one language corresponding to the country code by querying for the at least one language from the predefined corresponding relationship.

For example, a predefined corresponding relationship is shown in table 1 below. If the setting result for the region option of the electronic device is China, it may obtain the country code for China (i.e., 86) by reading the system property, and the corresponding languages are simplified Chinese and traditional Chinese.

TABLE 1

| Setting Result | Country Code | Language |
|---|---|---|
| China | 86 | simplified Chinese/traditional Chinese |
| Canada | 124 | English/French/Indian |
| . . . | . . . | . . . |

In step 206, the predefined language list which is pre-stored in the electronic device and remains unchanged may be read.

The electronic device pre-stores the predefined language list which contains languages corresponding to at least two regions, and ranking positions of languages in the predefined language list remain unchanged. The ranking positions of languages in the predefined language list may be ranked by popularity, order of initial letters of language names, or length of language names of each of the languages. The embodiments of the present disclosure are not limited in this respect.

For example, a predefined language list stored in an electronic device is shown in table 2 below.

TABLE 2

English
Simplified Chinese
French
Traditional Chinese
Korean
Japanese
Arabic
. . .

As an alternative solution for step 206, in step 207, the predefined language list is obtained by retrieving a previous setting result for the region option, and restoring at least one language, which is associated with the previous setting result, from a specified position to a respective initial position. In other words, the previous setting result is geographic location information previously acquired by the electronic device.

If it is not the first time for the user to set the language option, when obtaining the predefined language list, the electronic device may restore at least one language which is associated with the previous setting result for the language option to an initial position to obtain an original predefined language list.

Given that the previous setting result is China with simplified Chinese ranked in a first place and traditional Chinese ranked in a second place in the predefined language list, and the original predefined language list is shown as in table 2, it may restore simplified Chinese from the first place to a second place, and traditional Chinese from the second place to a fourth place.

Steps 206 and 207 need to be performed before step 208. However, the embodiments of the present disclosure are not limited to a particular sequence of steps 206, 207 and other steps.

In step 208, at least one language which is associated with the setting result may be extracted from the predefined language list.

The predefined language list contains at least one language corresponding to each of regions. Since it may obtain at least one language corresponding to the setting result, the electronic device may directly extract the at least one language from the predefined language list.

In step 209, popularity of the at least one language may be obtained.

The popularity of language may represent a probability for the user to select the language as the setting result for the language option. The popularity is positively correlated with the probability. In other words, the higher the popularity is, the greater the probability for the user to select a language as the setting result for the language option it will be.

The popularity of language can be obtained by statistically analyzing setting results for the language option from a plurality of users. The embodiments of the present disclosure are not limited in this respect.

In step 210, the at least one language may be ranked in descending order of the popularity.

In step 211, the ranked at least one language may be inserted into the specified position in the predefined language list.

Since a language with higher popularity may have greater probability to be selected by the user, the user may directly select the language with higher popularity according to the order. Thus, the user does not have to search at least one language for a language, and, accordingly, the efficiency for setting the language option of the electronic device is improved.

The specified position refers to a position which can be displayed on the current interface. For example, if the electronic device displays the predefined language list from front to back, the specified position may be the top n places in the predefined language list, wherein n is a positive integer. If the electronic device displays the predefined language list in a roller manner, the specified position may be a position at the center of the roller.

In step 212, the at least one language which is in the specified position may be displayed on the current interface of the electronic device.

In one possible implementation, the electronic device may display an operation widget of the predefined language list on the interface. The user may trigger the operation widget by manual. After receiving the trigger operation, the electronic device will display, on the current interface, the at least one language which is in the specified position for the user to select.

In another possible implementation, after setting the region information, the electronic device will automatically display, on its current interface, the at least one language which is in the specified position for the user to select, without the user's trigger operation, which may reduce operations performed by the user during the process of setting the language option, and thus improve the efficiency for setting the language option.

For example, as shown in FIG. 2D, if it is determined that the setting result for the region option is China, the electronic device will display simplified Chinese and traditional Chinese in the top two places on its current interface in descending order of the popularity. FIG. 2D takes display interface 1 as an example of the display interface which displays the setting result for the region option. When implemented in practice, the electronic device may jump to a new display interface to display the predefined language list after the determination of the setting result for the region option. The embodiments of the present disclosure are not limited in this respect.

In step 213, language setting information may be received, and a language indicated by the language setting information may be selected as the setting result for the language option of the electronic device.

The user may select one of the at least one language displayed on the current interface. Then, the electronic device may receive the language setting information triggered by the user, and select the language indicated by the language setting information as the setting result for the language option.

Alternatively, if the user has no need to select one of the at least one language, the user may also select a language in other positions in the predefined language list. Then, the electronic device may receive the language setting information triggered by the user, and select the language indicated by the language setting information as the setting result for the language option.

For example, as shown in FIG. 2E, there are a plurality of languages provided in display interface 1 of the electronic device. The user selects simplified Chinese from the plurality of languages. Then, the electronic device selects simplified Chinese as the setting result for language option 5.

In the embodiment, except that a position of at least one language which is associated with the present setting result is changed, the remaining languages are in respective initial positions and remain unchanged. If the user has no need to select one of the at least one language, but needs to select a language from other positions, it may ensure the user can immediately locate the initial position of the language and thus find the language quickly. The embodiments avoids that ranking the at least one language which is associated with the present setting result in the specified position and ranking at least one language which is associated with the previous setting result in a position adjacent to the specified position will result in unfixed positions of other languages, which is not convenient for the user to search, and, accordingly, the efficiency for searching languages is improved.

The method for language setting provided in the present disclosure may enable the electronic device to directly provide the at least one language to a subsequent user when setting a language option, so that the user can obtain the at least one language associated with the present region without scrolling up and down to search the language list, and directly select one of the at least one language as the setting result for the language option of the electronic device. Thus, the user does not have to scroll the language list up and down to find a language associated with the present region after setting the region option, and, accordingly, the efficiency for setting the language option of the electronic device is improved.

In addition, by displaying, on the current interface of the electronic device, the at least one language which is in the specified position; receiving language setting information; and selecting a language indicated by the language setting information as a setting result for the language option of the electronic device, the electronic device may display the at least one language associated with the present region. Due to a great probability for the at least one language being set as the setting result for the language option, the probability for the user to select a language from the displayed at least one language as the setting result for the language option will be greater, which improves the efficiency for setting the language option.

In addition, by ranking at least one language in each region by popularity; and inserting the ranked at least one language into the specified position in the predefined language list, the embodiment described herein enables the user to directly select a language with high popularity according to the rank, since the probability for the user to select a language with high popularity is greater. Thus, the user does not have to find a language from the at least one language, and thus achieving an effect that improves the efficiency for setting the language option of the electronic device.

In addition, the predefined language list is obtained by retrieving the previous setting result for the region option, and restoring at least one language which is associated with the previous setting result from the specified position to a respective initial position, or the predefined language list which is pre-stored in the electronic device and remains unchanged is read, the embodiments described herein enable that except a position of at least one language associated with the present setting result is changed, the remaining languages are in respective initial positions and remain unchanged. If the user has no need to select one of the at least one language, but needs to select a language from other positions, it may ensure the user can immediately locate the initial position of the language and thus find the language quickly. The embodiment avoids that ranking the at least one language which is associated with the present setting result in the specified position and ranking at least one language which is associated with the previous setting result in a position adjacent to the specified position will result in unfixed positions of other languages, which is not convenient for the user to search for a language, and, accordingly, improves the efficiency for searching languages is improved.

In a second implementation, the current geographic location information of the electronic device is determined by a subscriber identification module (SIM) card in the electronic device. In this case, steps 201-203 can be substituted for the following steps 201f and 202f Referring to FIG. 2F, which is a flow diagram illustrating a method for language setting according to another exemplary embodiment. As shown in FIG. 2F, the method for language setting includes the following steps.

In step 201f, geographic location information indicated by a SIM card in the electronic device may be obtained.

In step 202f, the geographic location information indicated by the SIM card may be selected as the current geographic location information of the electronic device.

In the case that the electronic device obtains the current geographic location information by obtaining the geographic location information indicated by the SIM card, the electronic device may read IMSI (International Mobile Subscriber Identification Number) indicated in a predefined field in the SIM card, and determine the current geographic location information based on the IMSI. Herein, the IMSI includes at least a MCC (Mobile Country Code), which consists of a three-digit numbers and is used to uniquely identify a country where the SIM card belongs to. For example, if MCC is 460, it indicates that the country, where the SIM card belongs to, is China.

In this case, in step 204f, as an alternative step for step 204, a country code of the geographic location information may be read from a system property of the electronic device.

In step 207f, as an alternative step for step 207, the predefined language list is obtained by retrieving previously acquired geographic location information and restoring at least one language which is associated with the previously acquired geographic location information from the specified position to a respective initial position.

In step 208f, as an alternative step for step 208, at least one language which is associated with the geographic location information may be extracted from the predefined language list.

In a third implementation, the current geographic location information of the electronic device is determined based on network information which is registered by the electronic device. In this case, steps 201-203 can be substituted for the following steps 201g and 202g. Referring to FIG. 2Q which is a flow diagram illustrating a method for language setting according to another exemplary embodiment. As shown in FIG. 2Q the method for language setting includes the following steps.

In step 201g, geographic location information indicated in network information which is registered by the electronic device may be obtained.

In step 202g, the geographic location information indicated in the network information may be selected as the current geographic location information of the electronic device.

In the case that the electronic device obtains the current geographic location information by obtaining the geographic location information indicated in network information which is registered by the electronic device, the electronic device may receive network information carrying an IMSI broadcast by a base station; read the IMSI in the network information; and determine the current geographic location information of the electronic device based on the IMSI. A description related to the IMSI has been discussed in embodiments illustrated in FIG. 2F and will not be repeated herein.

In this case, in step 204g, as an alternative step for step 204, a country code of the geographic location information may be read from a system property of the electronic device.

In step 207g, as an alternative step for step 207, the predefined language list is obtained by retrieving previously acquired geographic location information and restoring at least one language which is associated with the previously acquired geographic location information from the specified position to a respective initial position.

In step 208g, as an alternative step for step 208, at least one language which is associated with the geographic location information may be extracted from the predefined language list.

In a fourth implementation, the current geographic location information of the electronic device is determined based on a GPS. In this case, steps 201-203 can be substituted for the following steps 201h and 202h. Referring to FIG. 2H, which is a flow diagram illustrating a method for language setting according to another exemplary embodiment. As shown in FIG. 2H, the method for language setting includes the following steps.

In step 201h, geographic location information using the GPS may be obtained.

In step 202h, the geographic location information obtained by the GPS may be selected as the current geographic location information of the electronic device.

In the case that the electronic device obtains the current geographic location information using the GPS, the electronic device may calculate current latitude and longitude information of the electronic device based on a GPS signal received by a GPS receiver in the electronic device, and determine the current geographic location information of the electronic device based on the calculated latitude and longitude information.

In this case, in step 204h, as an alternative step for step 204, a country code of the geographic location information may be read from a system property of the electronic device.

In step 207h, as an alternative step for step 207, the predefined language list is obtained by retrieving previously acquired geographic location information and restoring at least one language which is associated with the previously acquired geographic location information from the specified position to a respective initial position.

In step 208h, as an alternative step for step 208, at least one language which is associated with the geographic location information may be extracted from the predefined language list.

Alternatively, in a situation that the electronic device is exported from a first region to a second region, and a language in the first region is different with that of the second region, if the electronic device sets the language in the first region as a default language, then a user from the second region may be unable to understand the language in the first region, resulting in unavailability of the electronic device. Thus, the electronic device may obtain current geographic location information when it is booted for the first time. After obtaining the current geographic location information, the electronic device may extract at least one language which is associated with the geographic location information from the predefined language list, insert the at least one language into the specified position of the predefined language list, and select one of the at least one language which is associated with the geographic location information as the setting result for the language option of the electronic device, so that the language is selected as the default language of the electronic device, which improves a probability for normal use of the electronic device. The electronic device may obtain the current geographic location information in the way illustrated in either steps 201-203 in FIG. 2A, steps 201f-202f in FIG. 2F, steps 201g-202g in FIG. 2Q or steps 201h-202h in FIG. 2H. The embodiments of the present disclosure are not limited in this respect.

Herein, when the electronic device selects one of the at least one language as the setting result for the language option, it may select any of the at least one language based on a randomized algorithm; or it may select a language with highest popularity based on popularity of the at least one language; or it may select a language ranked in the top based on the arrangement of initial letters of the at least one language. The embodiments of the present disclosure are not limited in the way to select one of the at least one language.

Alternatively, when the electronic device is booted for the first time and after geographic location information has been obtained, it may directly determine at least one language associated with the geographic location information from the predefined language list of the electronic device, and select one of the at least one language as the setting result for the language option of the electronic device, so that the language is selected as a default language of the electronic device, which improves a probability for normal use of the electronic device. The current geographic location information of the electronic device may be obtained in the way illustrated in either steps 201-203 in FIG. 2A, steps 201f-202f in FIG. 2F, steps 201g-202g in FIG. 2Q or steps 201h-202h in FIG. 2H. The embodiments of the present disclosure are not limited in this respect.

When the electronic device selects one of the at least one language as the setting result for the language option, it may select any of the at least one language based on a randomized algorithm; or it may select a language with highest popularity based on popularity of the at least one language; or it may select a language ranked in the top based on the arrangement of initial letters of the at least one language. The embodiments of the present disclosure are not limited in the way to select one of the at least one language.

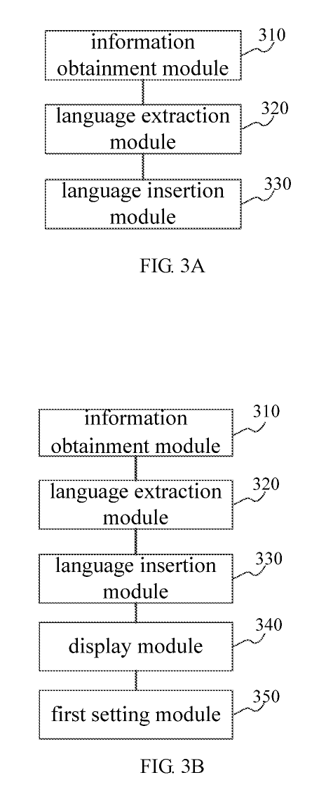

FIG. 3A is a block diagram illustrating a device for language setting according to an exemplary embodiment, which is applied in an electronic device. As shown in FIG. 3A, the device for language setting includes an information obtainment module 310, a language extraction module 320 and a language insertion module 330.

The information obtainment module 310 is configured to obtain current geographic location information of the electronic device.

The language extraction module 320 is configured to extract at least one language from a predefined language list, wherein the at least one language is associated with the geographic location information obtained by the information obtainment module 310.

The language insertion module 330 is configured to insert the at least one language which is extracted by the language extraction module 320 into a specified position in the predefined language list.

Thus, the device for language settings provided in the present disclosure can directly provide the at least one language to a subsequent user when setting a language option, so that the user can search the language list to obtain the at least one language which is associated with the current geographic location information without scrolling the language list up and down, and directly select one of the at least one language as the setting result for the language option of the electronic device. Thus, the user does not have to search the language list for a language which is associated with the geographic location information by scrolling it up and down after setting a region option, and, accordingly, the efficiency for setting the language option of the electronic device is improved.

Alternatively, referring to FIG. 3B, which is a block diagram illustrating a device for language setting. As shown in FIG. 3B, the device may further include a display module 340 and a first setting module 350.

The display module 340 is configured to display, on a current interface of the electronic device, the at least one language in the specified position determined by the language insertion module 330.

The first setting module 350 is configured to receive language setting information, and select a language indicated in the language setting information as a setting result for a language option of the electronic device.

Thus, by displaying, on the current interface of the electronic device, the at least one language which is in the specified position; receiving language setting information; and selecting a language indicated by the language setting information as the setting result for the language option of the electronic device, the device for language setting provided in the embodiments of the present disclosure may display the at least one language which is associated with the current geographic location information. Due to a great probability for the at least one language being set as the setting result for the language option, the probability for the user to select a language from the displayed at least one language as the setting result for the language option is greater, which improves the efficiency for setting the language option.

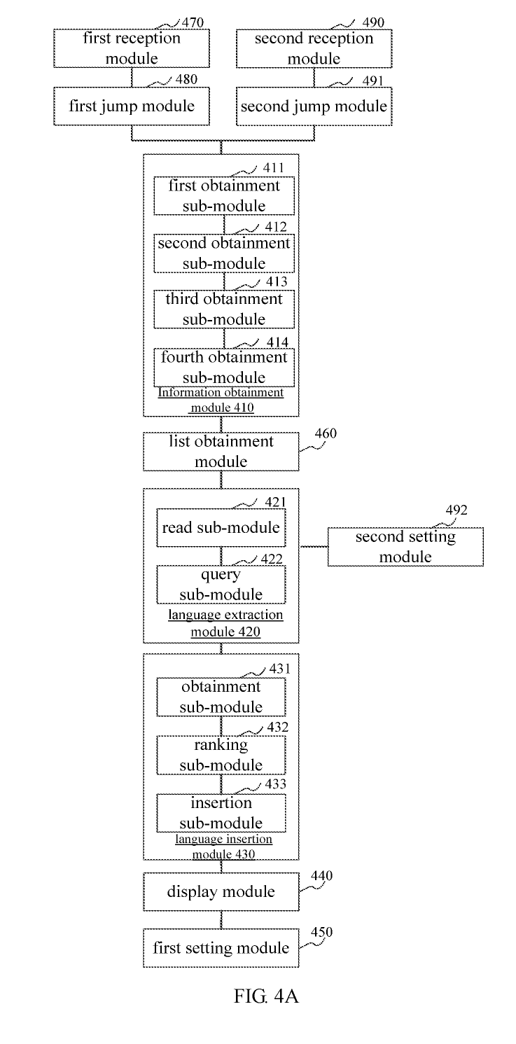

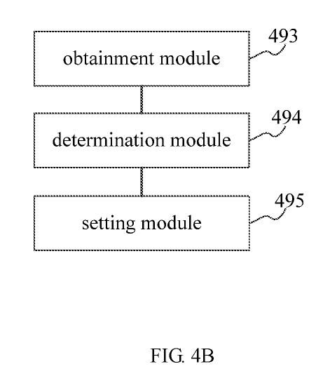

FIG. 4A is a block diagram illustrating a device for language setting according to an exemplary embodiment, which is applied in an electronic device. As shown in FIG. 4A, the device for language setting includes an information obtainment module 410, a language extraction module 420 and a language insertion module 430.

The information obtainment module 410 is configured to obtain current geographic location information of the electronic device.

The language extraction module 420 is configured to extract at least one language from a predefined language list, wherein the at least one language is associated with the geographic location information obtained by the information obtainment module 410.

The language insertion module 430 is configured to insert the at least one language which is extracted by the language extraction module 420 into a specified position in the predefined language list.

Alternatively, the device may further include a display module 440 and a first setting module 450.

The display module 440 is configured to display, on a current interface of the electronic device, the at least one language in the specified position determined by the language insertion module 430.

The first setting module 450 is configured to receive language setting information, and select a language indicated in the language setting information as a setting result for a language option of the electronic device.

Alternatively, the language insertion module 430 may include an obtainment sub-module 431, a ranking sub-module 432 and an insertion sub-module 433.

The obtainment sub-module 431 is configured to obtain popularity of the at least one language.

The ranking sub-module 432 is configured to rank the at least one language obtained by the obtainment sub-module 431 in descending order of the popularity.

The insertion sub-module 433 is configured to insert the at least one language, which is ranked by the ranking sub-module 432, into the specified position in the predefined language list.

Alternatively, the device may further include a list obtainment module 460.

The list obtainment module 460 is configured to obtain the predefined language list by retrieving previously acquired geographic location information and restoring the at least one language which is associated with the previously acquired geographic location information from the specified position to a respective initial position. Alternatively, the list obtainment module 460 is configured to read the predefined language list which is pre-stored in the electronic device and remains unchanged.

Alternatively, the language extraction module 420 may include a read sub-module 421 and a query sub-module 422.

The read sub-module 421 is configured to read a country code of the geographic location information from a system property of the electronic device.

The query sub-module 422 is configured to query for the at least one language corresponding to the country code read from a predefined corresponding relationship by the read sub-module 421, wherein the predefined corresponding relationship is used for storing a corresponding relationship between a country code and a language.

Alternatively, the information obtainment module 410 may include a first obtainment sub-module 411, a second obtainment sub-module 412, a third obtainment sub-module 413 and a fourth obtainment sub-module 414.

The first obtainment sub-module 411 is configured to obtain a setting result for a region option of the electronic device, and select geographic location information indicated in the setting result as the current geographic location information of the electronic device.

Alternatively, the second obtainment sub-module 412 is configured to obtain geographic location information indicated by a subscriber identification module (SIM) card in the electronic device, and select the geographic location information indicated by the SIM card as the current geographic location information of the electronic device.

Alternatively, the third obtainment sub-module 413 is configured to obtain geographic location information indicated in network information which is registered by the electronic device, and select the geographic location information indicated in the network information as the current geographic location information of the electronic device.

Alternatively, the fourth obtainment sub-module 414 is configured to obtain geographic location information using a global positioning system (GPS), and select the geographic location information obtained by the GPS as the current geographic location information of the electronic device.

Alternatively, if the current geographic location information of the electronic device is the setting result for the region option of the electronic device, the device may further include a first reception module 470 and a first jump module 480.

The first reception module 470 is configured to receive region setting information, and select a region indicated in the region setting information as the setting result for the region option.

The first jump module 480 is configured to trigger the information obtainment module to obtain the current geographic location information of the electronic device.

Alternatively, if the current geographic location information of the electronic device is the setting result for the region option of the electronic device, the device may further include a second reception module 490 and a second jump module 491.

The second reception module 490 is configured to receive region setting information, and select a region indicated in the region setting information as the setting result for the region option.

The second jump module 491 is configured to receive a trigger operation for a language option, and trigger the information obtainment module 410 to obtain the current geographic location information of the electronic device according to the trigger operation.

Alternatively, the device may further include a second setting module 492.

The second setting module 492 is configured to select one of the at least one language as the setting result for the language option of the electronic device when it is booted for the first time.

Thus the device for language setting provided in the present disclosure enables the electronic device to directly provide the at least one language to a subsequent user when setting a language option, so that the user can obtain the at least one language associated with the current geographic location information without scrolling up and down to search the language list, and select one of the at least one language as a setting result for the language option of the electronic device. The user does not have to scroll the language list up and down to find a language associated with the current geographic location information, and, accordingly, the efficiency for setting the language option of the electronic device is improved.

In addition, by displaying, on the current interface of the electronic device, the at least one language which is in the specified position; receiving language setting information; and selecting a language indicated by the language setting information as a setting result for the language option of the electronic device, the electronic device may display the at least one language which is associated with the current geographic location information. Due to a great probability for the at least one language being set as the setting result for the language option, the probability for the user to select a language from the displayed at least one language as the setting result for the language option is greater, which improves the efficiency for setting the language option.

In addition, by ranking at least one language in each region by popularity and inserting the ranked at least one language into the specified position in the predefined language list, the embodiment described herein enables the user to directly select a language with high popularity according to the rank, since the probability for the user to select a language with high popularity is greater, thus, the user does not have to find a language from the at least one language, and thus improving the efficiency for setting the language option of the electronic device.

In addition, the predefined language list is obtained by retrieving previously acquired geographic location information and restoring at least one language which is associated with the previously acquired geographic location information from the specified position to a respective initial position, or the predefined language list which is pre-stored in the electronic device and remains unchanged is read, the embodiments described herein enable that except a position of at least one language associated with the present setting result is changed, the remaining languages are in respective initial positions and remain unchanged. If the user has no need to select one of the at least one language, but needs to select a language from other positions, it may ensure the user can immediately locate the initial position of the language and thus find the language quickly. The embodiment avoids that ranking the at least one language which is associated with the present setting result in the specified position and ranking at least one language which is associated with the previous setting result in a position adjacent to the specified position will result in unfixed positions of other languages, which is not convenient for the user to search, and thus the efficiency for searching languages is improved.

In addition, when the electronic device is booted for the first time, it may determine at least one language which is associated with current geographic location information of the electronic device, and select one of the at least one language as a default language of the electronic device. Thus, it avoids that the electronic device sets a language in a first region as the default language and is exported from the first region to a second region, since a language in the second region is different with that in the first region, a user from the second region may be unable to understand the language in the first region, resulting in unavailability of the electronic device, and thus improving a probability for normal use of the electronic device.

With respect to the device provided in the embodiments described above, implementations for performing operations by each of modules have been discussed in detail in the embodiments with respect to the method, and will not be repeated herein.

FIG. 4B is a block diagram illustrating a device for language setting according to another exemplary embodiment, which is applied in an electronic device. As shown in FIG. 4B, the device for language setting includes an obtainment module 493, a determination module 494 and a setting module 495.

The obtainment module 493 is configured to obtain current geographic location information of the electronic device when it is booted for the first time.

The determination module 494 is configured to determine, from a predefined language list of the electronic device, at least one language which is associated with the geographic location information obtained by the obtainment module 493.

The setting module 495 is configured to select one of the at least one language determined by the determination module 494, as a setting result for a language option of the electronic device.

An exemplary embodiment of the present disclosure provides a device for language setting for implementing the method for language setting provided in the present disclosure. The device includes a processor and a memory for storing processor-executable instructions, wherein the processor is configured to obtain current geographic location information of an electronic device; extract, from a predefined language list, at least one language which is associated with the geographic location information; and insert the at least one language into a specified position in the predefined language list.

An exemplary embodiment of the present disclosure provides a device for language setting for implementing the method for language setting provided in the present disclosure. The device includes a processor and a memory for storing processor-executable instructions, wherein the processor is configured to obtain current geographic location information of an electronic device when it is booted for the first time; determine, from a predefined language list of the electronic device, at least one language which is associated with the geographic location information; and select one of the at least one language as a setting result for a language option of the electronic device.

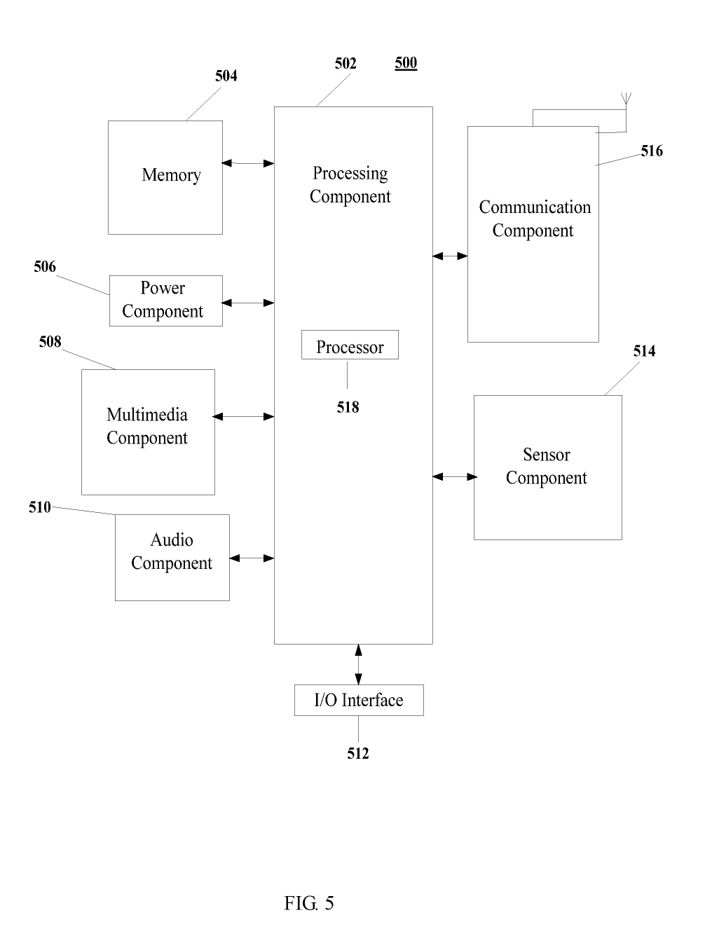

FIG. 5 is a block diagram illustrating a device for language setting according to an exemplary embodiment. For example, the device 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls overall operations of the device 500, such as the operations associated with display, phone calls, data communications, camera operations and recording operations. The processing component 502 may include one or more processors 518 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the device 500. Examples of such data include instructions for any applications or methods operated on the device 500, contacts data, telephone book data, messages, photos, videos, etc. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the device 500. The power component 506 may include a power management system, one or more power sources, and any other components associated with the generation, management, and distribution of power in the device 500.

The multimedia component 508 includes a screen providing an output interface between the device 500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 508 may include a front-facing camera and/or rear camera. When the device 500 is in operation mode, such as in shooting mode or video mode, the front-facing camera and/or rear camera may receive multimedia data from outside. Each of the front-facing camera and the rear camera may be a fixed optical lens system, or focus or optical zoom-enabled.

The audio component 510 is configured to output and/or input audio signals. For example, the audio component 510 includes a microphone (“MIC”) configured to receive an external audio signal when the device 500 is in an operation mode, such as a calling mode, a recording mode and a voice recognition mode. The received audio signal may be further stored in the memory 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the device 500. For instance, the sensor component 514 may detect an open/closed status of the device 500, relative positioning of components, e.g., the display and the keypad, of the device 500, a change in position of the device 500 or a component of the device 500, a presence or absence of user contact with the device 500, an orientation or an acceleration/deceleration of the device 500, and a change in temperature of the device 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor, or a temperature sensor.

The communication component 516 is configured to facilitate communication, wired or wirelessly, between the device 500 and other devices. The device 500 can access a wireless network based on a communication standard, such as WiFi, 2G or 3G or a combination thereof. In one example embodiment, the communication component 516 receives a broadcast signal or broadcast associated information from an external broadcast management system via a broadcast channel. In one example embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the device 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer readable storage medium including instructions, such as the memory 504 including instructions, executable by the processor 518 in the device 500, for performing the above-described methods. For example, the non-transitory computer-readable storage medium may be a ROM, a random access memory (RAM), a CD-ROM, a magnetic tape, a floppy disc, an optical data storage device, and the like.

Other embodiments will be apparent to those skilled in the art from consideration of the specification and practice of the disclosures herein. This application is intended to cover any variations, uses, or adaptations of the disclosure following the general principles thereof and including such departures from the present disclosure as come within known or customary practice in the art. It is intended that the specification and embodiments be considered as illustrative only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for language setting, comprising:
obtaining current geographic location information of an electronic device;
extracting at least one language which is associated with the geographic location information from a predefined language list; and
inserting the at least one language into a specified position in the predefined language list.

2. The method of claim 1, further comprising:
displaying, on a current interface of the electronic device, the at least one language which is in the specified position; and
receiving language setting information and selecting a language indicated by the language setting information as a setting result for a language option of the electronic device.

3. The method of claim 1, wherein inserting the at least one language into a specified position in the predefined language list comprises:
obtaining popularity of the at least one language;
ranking the at least one language in descending order of the popularity; and
inserting the ranked at least one language into the specified position in the predefined language list.

4. The method of claim 1, further comprising:
obtaining the predefined language list by retrieving previously acquired geographic location information and restoring at least one language which is associated with the previously acquired geographic location information from the specified position to a respective initial position.

5. The method of claim 1, further comprising:
reading the predefined language list which is pre-stored in the electronic device and remains unchanged.

6. The method of claim 1, wherein extracting at least one language which is associated with the geographic location information from a predefined language list comprises:
reading a country code of the geographic location information from a system property of the electronic device; and
querying for at least one language corresponding to the country code from a predefined corresponding relationship, wherein the predefined corresponding relationship is used for storing a corresponding relationship between a language and a country code.

7. The method of claim 1, wherein obtaining current geographic location information of an electronic device comprises:
obtaining a setting result for a region option of the electronic device, and selecting geographic location information indicated in the setting result as the current geographic location information of the electronic device; or
obtaining geographic location information indicated by a subscriber identification module (SIM) card in the electronic device, and selecting the geographic location information indicated by the SIM card as the current geographic location information of the electronic device; or
obtaining geographic location information indicated in network information which is registered by the electronic device, and selecting the geographic location information indicated in the network information as the current geographic location information of the electronic device; or
obtaining geographic location information using a global positioning system (GPS), and selecting the geographic location information obtained by the GPS as the current geographic location information of the electronic device.

8. The method of claim 7, wherein if the current geographic location information of the electronic device is the setting result for the region option of the electronic device, the method further comprises:
receiving region setting information, and selecting a region indicated in the region setting information as the setting result for the region option; and
triggering a performance of obtaining the current geographic location information of the electronic device.

9. The method of claim 7, wherein if the current geographic location information of the electronic device is the setting result for the region option of the electronic device, the method further comprises:
receiving region setting information, and selecting a region indicated in the region setting information as the setting result for the region option; and
receiving a trigger operation for a language option, and triggering a performance of obtaining the current geographic location information of the electronic device according to the trigger operation.

10. The method of claim 1, further comprising:
selecting one of the at least one language as the setting result for the language option of the electronic device when it is booted for the first time.

11. A method for language settings, comprising:
obtaining current geographic location information of an electronic device when it is booted for the first time;
determining at least one language which is associated with the geographic location information from a predefined language list of the electronic device; and
selecting one of the at least one language as a setting result for a language option of the electronic device.

12. A device for language settings, comprising:
a processor; and
a memory for storing processor-executable instructions;
wherein the processor is configured to:
obtain current geographic location information of an electronic device;
extract at least one language from a predefined language list, wherein the at least one language is associated with the obtained geographic location information; and
insert the extracted at least one language into a specified position in the predefined language list.

13. The device of claim 12, wherein the processor is further configured to:
display, on a current interface of the electronic device, the at least one language in the specified position; and
receive language setting information, and select a language indicated in the language setting information as a setting result for a language option of the electronic device.

14. The device of claim 12, wherein the processor is further configured to:
obtain popularity of the at least one language;
rank the at least one language in descending order of the popularity; and
insert the ranked at least one language into the specified position in the predefined language list.

15. The device of claim 12, wherein the processor is further configured to:
obtain the predefined language list by retrieving previously acquired geographic location information and restoring the at least one language which is associated with the previously acquired geographic location information from the specified position to a respective initial position.

16. The device of claim 12, wherein the processor is further configured to:
read the predefined language list which is pre-stored in the electronic device and remains unchanged.

17. The device of claim 12, wherein the processor is further configured to:
read a country code of the geographic location information from a system property of the electronic device; and
query for the at least one language corresponding to the country code of the geographic location information from a predefined corresponding relationship, wherein the predefined corresponding relationship is used for storing a corresponding relationship between a country code and a language.

18. The device of claim 12, wherein the processor is further configured to:
obtain a setting result for a region option of the electronic device, and select geographic location information indicated in the setting result as the current geographic location information of the electronic device; or
obtain geographic location information indicated by a subscriber identification module (SIM) card in the electronic device, and select the geographic location information indicated by the SIM card as the current geographic location information of the electronic device; or
obtain geographic location information indicated in network information which is registered by the electronic device, and select the geographic location information indicated in the network information as the current geographic location information of the electronic device; or
obtain geographic location information using a global positioning system (GPS), and select the geographic location information obtained by the GPS as the current geographic location information of the electronic device.

19. The device of claim 18, wherein if the current geographic location information of the electronic device is the setting result for the region option of the electronic device, the processor is further configured to:
receive region setting information, and select a region indicated in the region setting information as the setting result for the region option; and
trigger to obtain the current geographic location information of the electronic device.

20. The device of claim 18, wherein if the current geographic location information of the electronic device is the setting result for the region option of the electronic device, the processor is further configured to:
receive region setting information, and select a region indicated in the region setting information as the setting result for the region option; and
receive a trigger operation for a language option, and trigger to obtain the current geographic location information of the electronic device according to the trigger operation.

21. The device of claim 12, wherein the processor is further configured to:
select one of the at least one language as the setting result for the language option of the electronic device when it is booted for the first time.
